(19) United States
(12) Patent Application Publication
(10) Pub. No.: US 2019/0329541 A1
(43) Pub. Date: Oct. 31, 2019

(54) METHOD FOR FORMING PROTECTIVE FILM ON FOAM CUSHION

(71) Applicants: HUNG YA WANG, Taichung City (TW); HUI LI WANG, Taichung City (TW)

(72) Inventor: HUNG YA WANG, Taichung City (TW)

(21) Appl. No.: 15/962,559

(22) Filed: Apr. 25, 2018

(51) Int. Cl. B32B 37/12; B32B 5/18; B32B 7/12; B32B 9/04; B32B 38/00; B32B 38/06

(52) U.S. Cl. CPC B32B 37/1207; B32B 5/18; B32B 7/12; B32B 9/046; B32B 2038/168; B32B 38/06; B32B 38/164; B32B 2037/1223; B32B 38/004

(57) ABSTRACT

A method for forming a protective film on a foam cushion including steps of preparing the cushion, applying a hot-melt adhesive, hot pressing a resin film, and cutting. Therein, the cushion is applied with a hot-melt adhesive layer, and a heated metal roller is used to press the resin film onto the hot-melt adhesive layer. The melting point of the resin film is greater than that of the hot-melt adhesive layer, and the heating temperature of the metal roller is between the melting point of the resin film and the melting point of the hot-melt adhesive layer, so that while the resin film is pressed on the hot-melt adhesive layer by the metal roller, the resin film is stuck by the hot-melt adhesive layer, thereby forming a protective film on the outer surface. The method features quick resin film and reliable film affixation.

### BACKGROUND OF THE INVENTION

### 1. Technical Field

The present invention relates to manufacturing of foam cushions, and more particularly to a method for forming a protective film on a foam cushion.

### 2. Description of Related Art

FIGS. 9(a)-(b) illustrate a conventional process of producing a foam cushion. As shown, a cushion 9 made through compression molding is transversely split into two halves 91 (along the dotted line in the drawing). Then the cur surface 911 of the half 91 is pressed by a roller 92 to form an embossed surface. Afterward, the half 91 is cut into the desired size to be served as a foam cushion with an embossed surface. However, air bubbles tend to form during the foaming process for making the cushion 9 if air is not fully expelled, and these air bubbles become minute cells inside the cushion 9. In the event that such cells are located at where the cushion 9 is split, the open cells exposed at the split surface 911 may have dirt built up therein and make cleaning of the cushion 9 difficult.

FIGS. 10 (a)-(e) illustrates a method for making another conventional foam cushion. Different from the previously discussed known method for making a foam cushion, the cushion 9 transversely split into two halves 91 has its split surface 911 provided with an ink layer 93 that is made by printing a graph with ink. After the ink layer 93 is baked to dry, a roller 92 is used to press the split surface 911 carrying the ink layer 93 to form the embossed surface. However, since the ink layer 93 on the split surface 91 is exposed to the outside without protection, after the resulting foam cushion is used for a period of time, with frequent tread or friction caused by similar movements, the ink layer 93 can be scratched or worn, making the foam cushion esthetically undesired.

In view of the foregoing problems, the inventor of the present invention has invented and been granted with Taiwan Patent No. 1606930, titled “Method for Applying Resin film on Foam Cushion”, which involves applying a layer of adhesive onto a split surface of a previously prepared cushion, using a heater to heat and soften the split surface coated with the adhesive, and using a roller having an embossed pattern to press a protective film onto the cushion so that the adhesive adheres the protective film. The protective film adhered to the split surface thus can protect the embossed surface of the cushion form dirt, scratches and wear.

There are two ways to bind adhesive and the protective film together:

1. Use of adhesive containing a highly volatile solvent. This approach, however, tends to cause air bubbles formed between the adhesive and the protective film when the solvent evaporates. Such air bubbles are esthetically adverse to the finished product and can lead to degraded affixation.

2. Use of adhesive with low volatility. This approach requires the protective film to be placed on the adhesive after the adhesive reaches its semi-dried state. While this approach effectively prevents formation of air bubbles, it would be a challenge to accurately determine that the adhesive has reaches its semi-dried state. Besides, it is not easy for the semi-dried adhesive to permeate the open cells on the split surface of the cushion, also leading to degraded affixation.

### SUMMARY OF THE INVENTION

The primary objective of the present invention is to provide a method for forming a protective film on a foam cushion. The method features quick film affixation, and eliminates the risk of air bubbles formed under the affixed resin film, thereby significantly improving reliability of affixation of the resin film.

To achieve the foregoing objective, the disclosed method for forming a protective film on a foam cushion comprising the following steps:

preparing the cushion: preparing the cushion by forming a foam material so that the cushion has an outer surface;

applying a hot-melt adhesive: applying a layer of a hot-melt adhesive onto the outer surface;

hot pressing a resin film: hot pressing a resin film onto the hot-melt adhesive layer using a heated metal roller, wherein the resin film has a melting point greater than a melting point of the hot-melt adhesive layer, and the metal roller has a heating temperature that is between the melting point of the resin film and the melting point of the hot-melt adhesive layer, so that when pressed onto the hot-melt adhesive layer by the metal roller, the resin film is stuck by the hot-melt adhesive layer, thereby forming the protective film on the split surface.

Preferably, the step of applying the hot-melt adhesive comprises applying a liquid hot-melt adhesive containing a solvent onto the outer surface, and setting the cushion aside for a predetermined period to let the solvent evaporate and let the liquid hot-melt adhesive dry, so that the hot-melt adhesive layer formed on the outer surface is a solvent-free, solid foil. The step of applying the hot-melt adhesive comprises applying a liquid hot-melt adhesive containing a solvent onto the outer surface, and setting the cushion aside for a predetermined period to let the solvent evaporate and let the liquid hot-melt adhesive dry, so that the hot-melt adhesive layer formed on the outer surface is a solvent-free, solid foil.

### BRIEF DESCRIPTION OF THE DRAWINGS

FIG. 1 is a flowchart of the method of the present invention.

FIG. 2 illustrates a method according to a first embodiment of the present invention.

FIG. 3 illustrates a rolling process in the first embodiment of the present invention.

FIG. 4 illustrates an alternative rolling process in the first embodiment of the present invention.

FIG. 5 illustrates a method according to a second embodiment of the present invention.

FIG. 6 illustrates a method according to a third embodiment of the present invention.

FIG. 7 is an enlarged view of FIG. 6 (c).

FIG. 8 illustrates a method according to a fourth embodiment of the present invention.

FIG. 9 illustrates a conventional way of resin film affixation for a foam cushion.

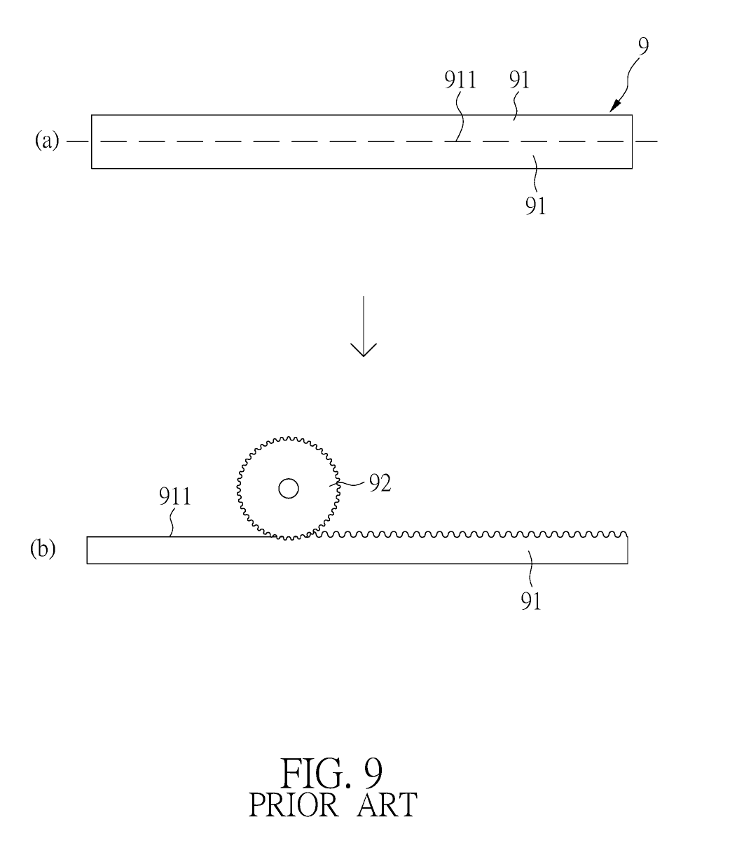

FIG. 10 illustrates another conventional way of resin film affixation for a foam cushion.

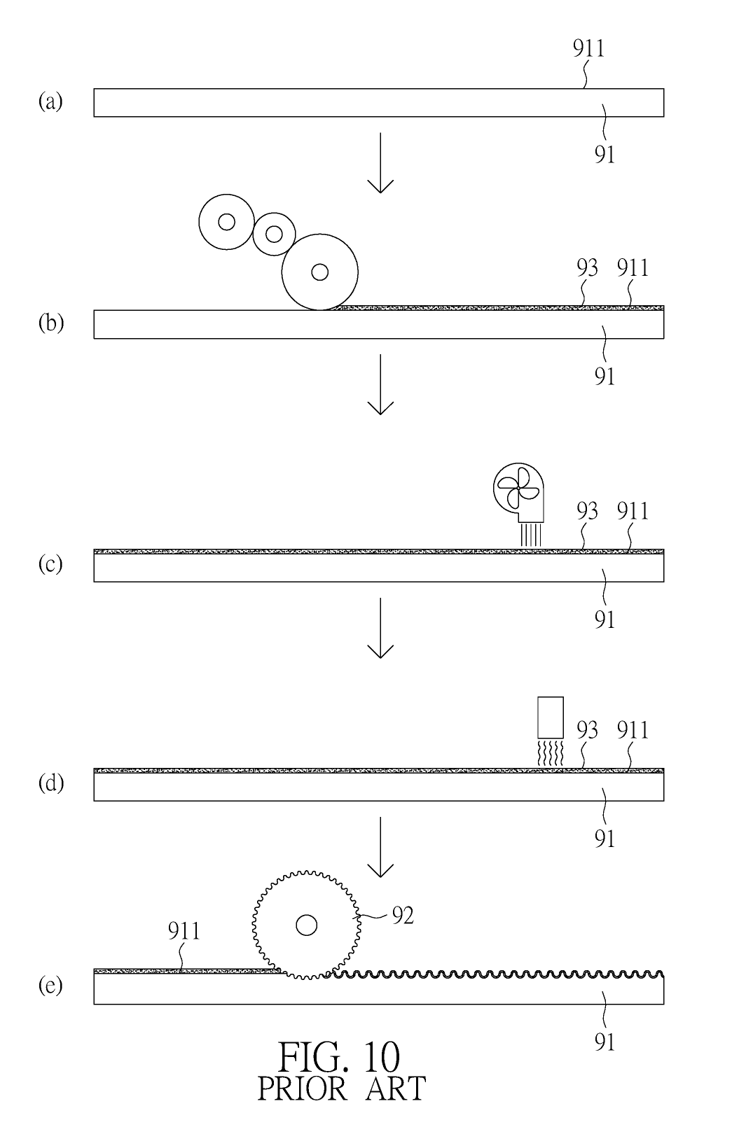

### DETAILED DESCRIPTION OF THE INVENTION

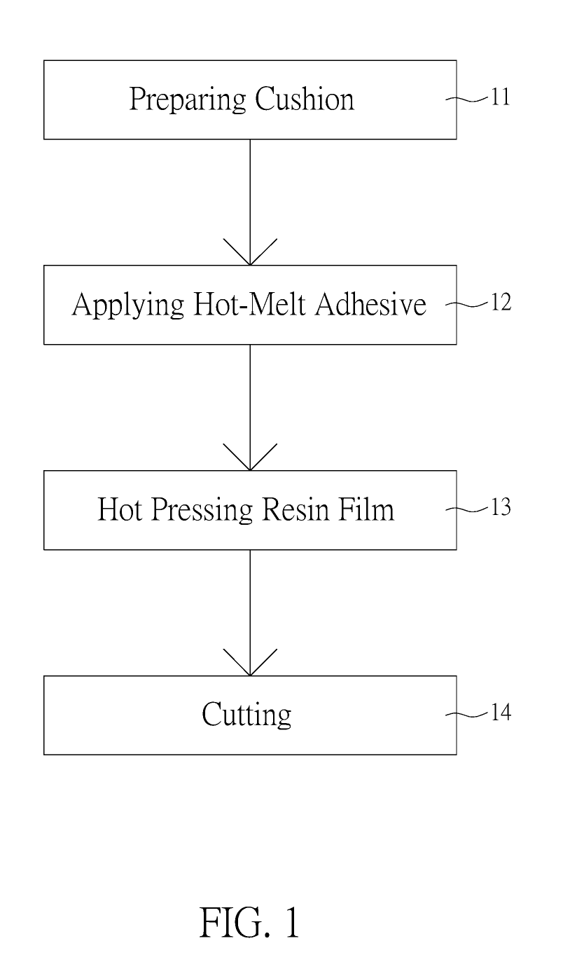

The present invention provides a method for forming a protective film on a foam cushion. FIG. 1 illustrates the first embodiment of the present invention. As shown, the method comprises steps of preparing a cushion 11, applying a hot-melt adhesive 12, hot pressing a resin film 13, and cutting 14, which will be described in detail below.

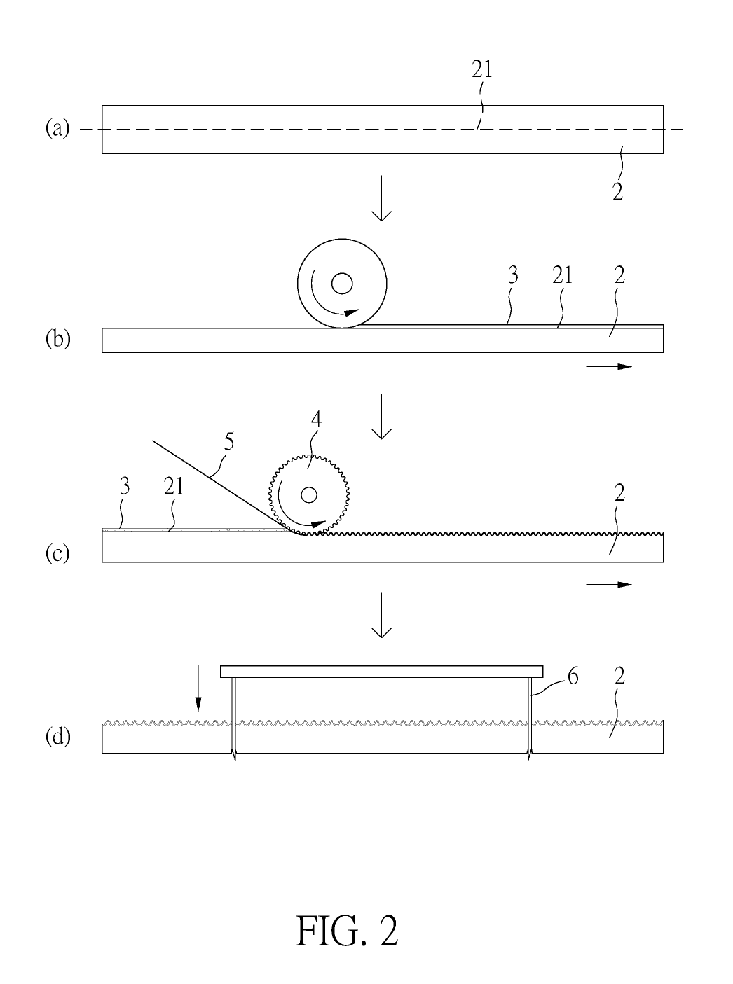

Referring to FIG. 2(a), in the step of preparing the cushion 11, the cushion 2 is prepared by forming a foam material. The cushion 2 has an even outer surface 21. In the present embodiment, the cushion 2 is transversely split so that it has an even outer surface 21. Alternatively, the cushion 2 may be such formed that it has an even outer surface 21, and in this case, transverse splitting of the cushion 2 can be omitted and its outer surface can be directly used as the outer surface to which a hot-melt adhesive 12 is applied.

Referring to FIG. 2(b), after the step of preparing the cushion 11 is done, the outer surface 21 of the cushion 2 is applied with a hot-melt adhesive layer 3, so as to accomplish the step of applying the hot-melt adhesive 12. To form the hot-melt adhesive layer 3 on the outer surface 21, a liquid hot-melt adhesive containing a solvent is applied to the outer surface 21, and then the cushion 2 together with the liquid hot-melt adhesive is set aside for a predetermined period so as to let the solvent evaporate and become dry. The hot-melt adhesive layer 3 so formed on the outer surface 21 is a solvent-free, solid foil. The hot-melt adhesive layer 3 when heated to its melting point can melt into highly sticky adhesive.

Referring to FIG. 2 (c), after the step of applying the hot-melt adhesive 12 is done, a heated metal roller 4 is used to press a resin film 5 onto the hot-melt adhesive layer 3. In the present embodiment, the metal roller 4 has its surface provided with an embossed pattern 41, so that when the resin film 5 is pressed and affixed to the hot-melt adhesive layer 3 by the metal roller 4, an embossed surface 22 in accordance with the embossed pattern 41 is formed on the cushion 2, thereby finishing the step of hot pressing the resin film 13. Therein, the melting point of the resin film 5 is greater than the melting point of the hot-melt adhesive layer 3, and the heating temperature of the metal roller 4 is such set that it is between the melting point of the resin film 5 and the melting point of the hot-melt adhesive layer 3. When the resin film 5 is pressed onto the hot-melt adhesive layer 3 by the metal roller 4, the hot-melt adhesive layer 3 is heated to its melting point and melted into a sticky state and in turn sticks the resin film 5 pressed thereon by the metal roller 4, thereby forming a protective film on the outer surface 21 of the cushion 2.

Referring to FIG. 2 (d), after the step of hot pressing the resin film 13 is done, a cutter 6 is used to cut the cushion 2 into any desired shapes, so as to finish the final step of cutting 14.

Since the outer surface 21 is formed by transversely splitting the cushion 2, air bubbles generated during the foaming process for making the cushion 2 can be exposed at the outer surface 21 as minute, open cells. These open cells can be covered by the resin film 5 affixed to the hot-melt adhesive layer 3, so that even when dirt comes to the surface of the cushion 2, dirt can only touches the resin film 5 instead of entering these open cells, thereby effectively preventing dirt from building up.

Moreover, in the present invention, since the hot-melt adhesive layer 3 is provided as the binding medium between the cushion 2 and the resin film 5, the resin film 5 can be rapidly affixed to the outer surface 21 of the cushion 2 after a single time rolling of the heated metal roller 4. In addition, with the force applied by the metal roller 4, the melted hot-melt adhesive layer 3 can effectively permeate into the open cells at the outer surface 21, thereby improving affixation. In the step of hot pressing the resin film 13, the hot-melt adhesive layer 3 in the solid state contains no volatile solvent. This eliminates the risk of having air bubbles formed under the resin film 5 due to solvent evaporation, thereby further improving reliability of affixation of the resin film 5.

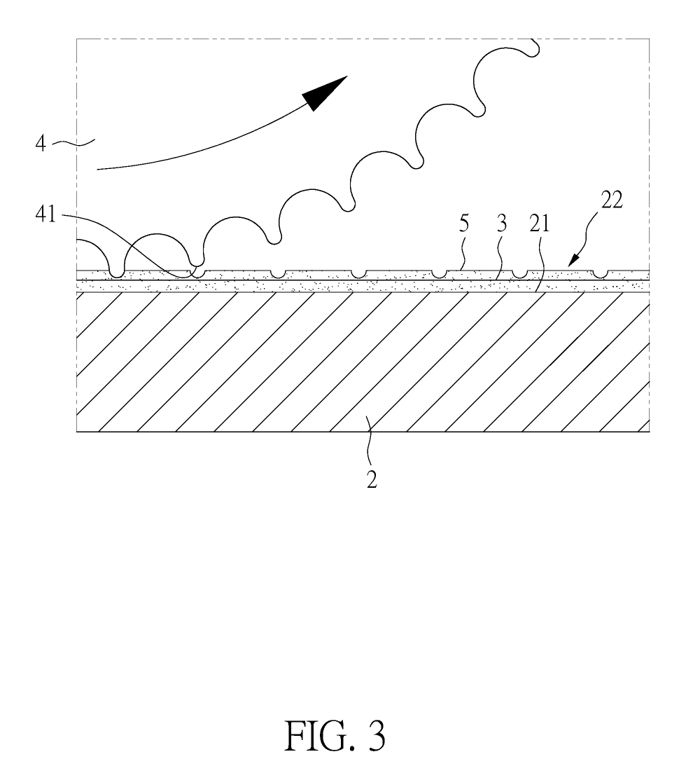

There are of course many examples of practical application base on the present embodiment. In one such example, as shown in FIG. 3, the metal roller 4 has its surface provided with an embossed pattern 41. Where the heating temperature of the metal roller 4 is such set that it is between the melting point of the resin film 5 and the melting point of the hot-melt adhesive layer 3 and is able to soften the resin film 5, when the metal roller 4 presses the resin film 5 into a predetermined press depth during the step of hot pressing the resin film 13, the resin film 5 is softened and takes the shape of the embossed pattern 41 of the metal roller 4, so that the resin film 5 has an embossed surface 22 in accordance with the embossed pattern 41 of the metal roller 4.

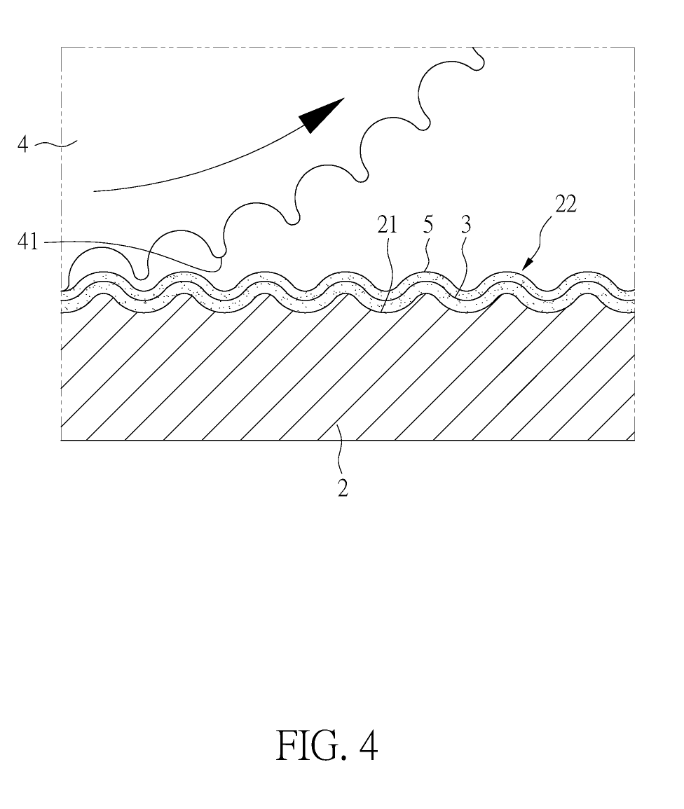

In another such example, as shown in FIG. 4, the metal roller 4 has its surface provided with an embossed pattern 41. Where the heating temperature of the metal roller 4 is such set that it is between the melting point of the resin film 5 and the melting point of the hot-melt adhesive layer 3 and is able to soften both the resin film 5 and the cushion 2 simultaneously, when the metal roller 4 presses the resin film 5 together with the hot-melt adhesive layer 5 and the outer surface 21 into a predetermined press depth during the step of hot pressing the resin film 13, they are softened and take the shape of the embossed pattern 41 of the metal roller 4, so that they have a surface 22 in accordance with the embossed pattern 41 of the metal roller 4.

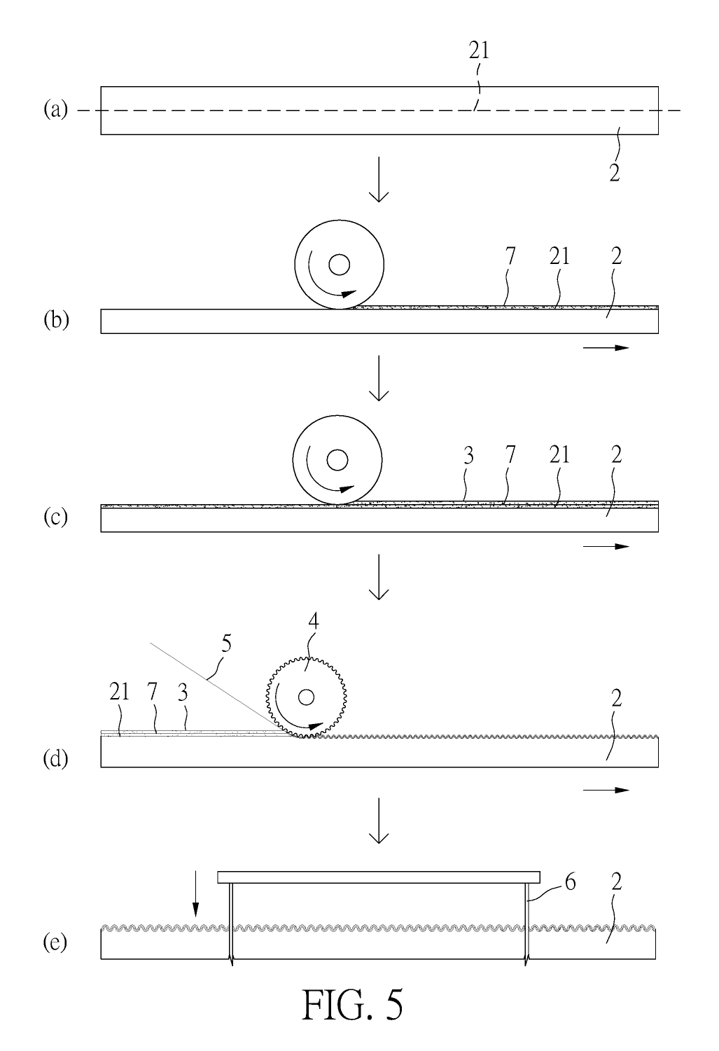

Further, the second embodiment of the present invention as shown in FIGS. 5(a)-(e) is similar to the foregoing first embodiment for having the steps of preparing a cushion 11, applying a hot-melt adhesive 12, hot pressing a resin film 13, and cutting 14, but the second embodiment has an additional step before the step of applying the hot-melt adhesive 12. In the additional step shown in FIG. 5(b), the outer surface 21 of the cushion 2 is provided with an ink layer 7 by printing a graph using ink. Then in the step of applying the hot-melt adhesive 12, the hot-melt adhesive layer 3 is applied on the ink layer 7 of the outer surface 21, before the step of hot pressing the resin film 13 (the resin film 5 used is transparent) and the step of cutting 14 are performed. Thereby a foam cushion having a protective film on its surface is also made.

From the above description about the second embodiment it is clear that the second embodiment, different from the first embodiment, uses the resin film 5 to protect the ink layer 7 printed on the outer surface 21, but not to protect the outer surface 21 having minute open cells. With the resin film, when the foam cushion such formed receives tread or friction form similar movements, the ink layer 7 is protected from scratches and wear, thereby securing the integrity of the graphic surface of the foam cushion, and also ensuring quick and reliable resin film affixation.

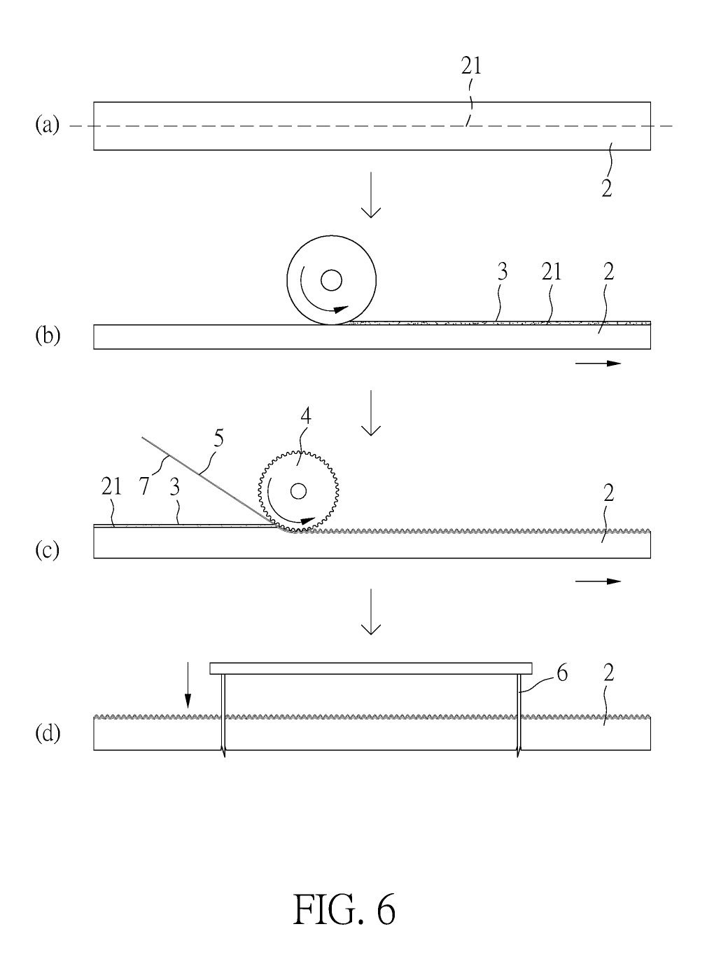

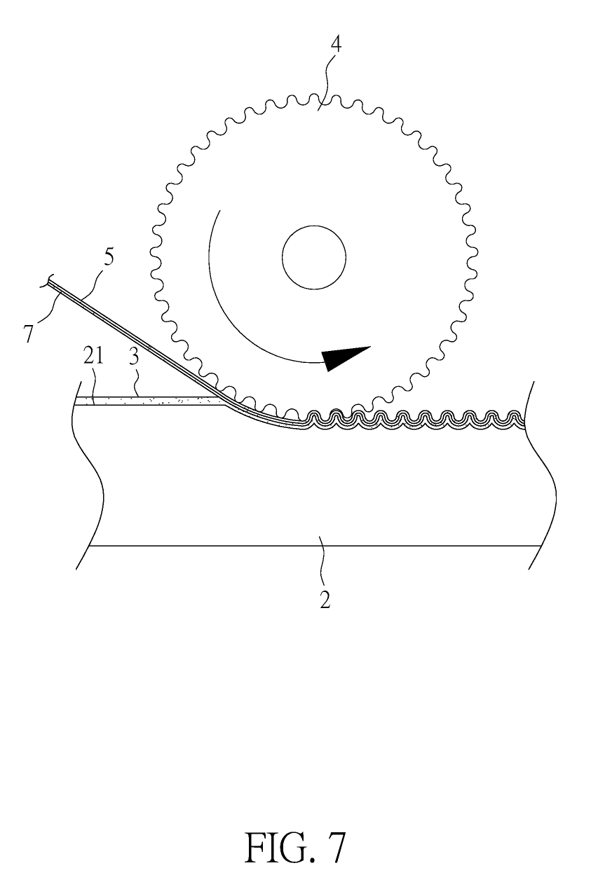

FIGS. 6(a)-(d) show the third embodiment of the present invention. Similar to the foregoing first embodiment, the method in the present embodiment has the steps of preparing a cushion 11, applying a hot-melt adhesive 12, hot pressing a resin film 13 and cutting 14. However, the third embodiment in the step of hot pressing the resin film 13 differently uses a transparent resin film 5 as shown in FIG. 7, and the resin film 5 has its inner surface previously provided with an ink layer 7 made by printing a graph with ink. Thus, when the heated metal roller 4 presses the resin film 5 onto the hot-melt adhesive layer 3, the graph of the ink layer 7 is sandwiched between the resin film 5 and the hot-melt adhesive layer 3. As a result, the third embodiment also features quick and reliable resin film affixation, and ensures integrity of the graph of the ink layer 7 on the foam cushion with the protection from the outside resin film 5.

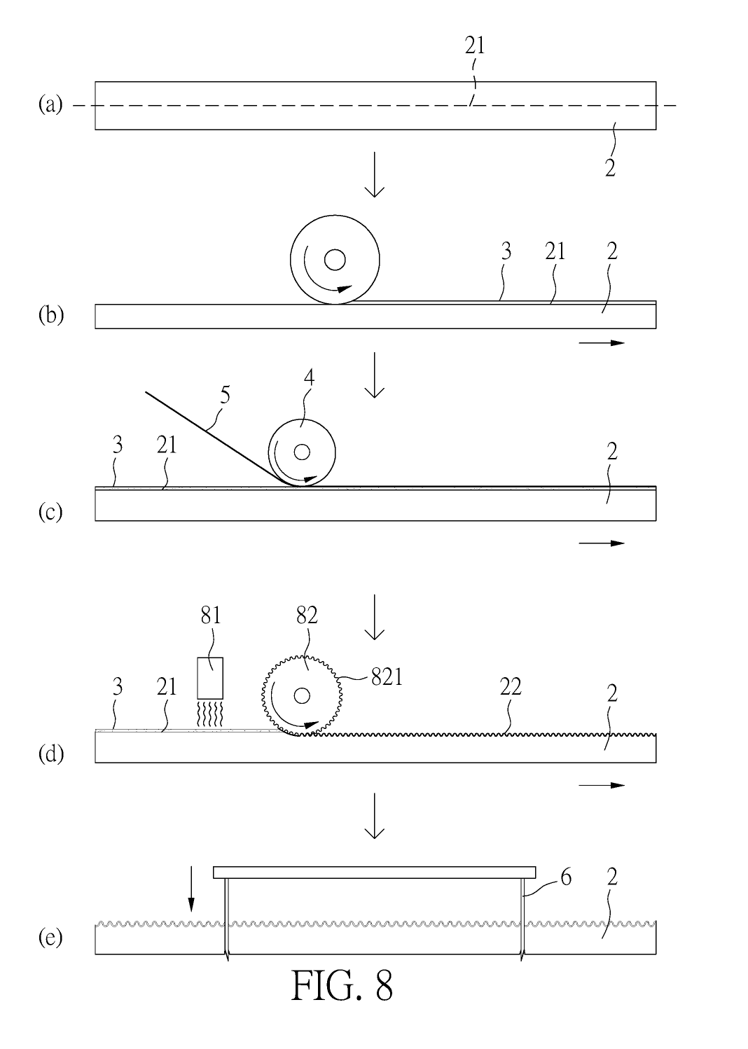

FIGS. 8(a)-(e) show the fourth embodiment of the present invention, which is different from the foregoing first embodiment for that in the step of hot pressing the resin film 13, as shown in FIG. 8(c), the metal roller 4 that is heated and presses the resin film 5 onto the hot-melt adhesive layer 3 has no embossed patterns, and that, as shown in FIG. 8(d), after the step of hot pressing the resin film 13 is done, a heater 81 is used to heat the cushion 2 with the resin film 5 affixed thereto before a forming roller 82 having an embossed pattern 821 is used to press the cushion 2, so as to endow the cushion 2 with an embossed surface 22 in accordance with the embossed pattern 821. The method is finished by performing the step of cutting 14, thereby producing a foam cushion having a protective film on its surface.

Similarly, by controlling the heating temperature of the heater 81 and the press depth of the forming roller 82, the fourth embodiment of the present invention can produce either a product wherein only the resin film 5 has the embossed surface 22 (as shown in FIG. 3), or a product where in the resin film 5 together with the hot-melt adhesive layer 3 and the outer surface 21 are all embossed (as shown in FIG. 4).

Furthermore, the fourth embodiment may be combined with the second embodiment wherein the ink layer 7 having a graph is formed on the outer surface 21 of the cushion 2 before the step of applying the hot-melt adhesive 12, and/or combined with the third embodiment wherein a transparent resin film 5 having its inner surface provided with an ink layer 7 having a graph is used in the step of hot pressing the resin film 13, so that the graph-carrying foam cushion can be ensured with graphic integrity in virtue of the protection from the outside resin film 5.

To sum up, the protective film made through the steps of applying the hot-melt adhesive 12 and hot pressing the resin film 13 in the method of the present invention can effectively cover the open cells exposed at the outer surface 21 of the cushion 2 during the foaming process or the ink layer 7 provided on the outer surface 21 of the cushion 2 or on the inner surface of the resin film 5, thereby preventing dirt accumulation and protecting the ink layer 7 from scratches and wear. The disclosed method features quick and reliable affixation of the resin film 5

What is claimed is:

1. A method for forming a protective film on a foam cushion, comprising steps of:
preparing the cushion by forming a foam material so that the cushion has an outer surface;
applying a layer of a hot-melt adhesive onto the outer surface;
hot pressing a resin film onto the hot-melt adhesive layer using a heated metal roller, wherein the resin film has a melting point greater than a melting point of the hot-melt adhesive layer, and the metal roller has a heating temperature that is between the melting point of the resin film and the melting point of the hot-melt adhesive layer, so that when pressed onto the hot-melt adhesive layer by the metal roller, the resin film is stuck by the hot-melt adhesive layer, thereby forming the protective film on the split surface.

2. The method of claim 1, wherein in the step of preparing the cushion, the cushion has been split to have the outer surface exposed outside.

3. The method of claim 1, wherein the step of applying the hot-melt adhesive comprises applying a liquid hot-melt adhesive containing a solvent onto the outer surface, and setting the cushion aside for a predetermined period to let the solvent evaporate and let the liquid hot-melt adhesive dry, so that the hot-melt adhesive layer formed on the outer surface is a solvent-free, solid foil.

4. The method of claim 3, wherein before the step of applying the hot-melt adhesive, there is a step of printing a graph with ink on the outer surface of the cushion to form an ink layer.

5. The method of claim 3, wherein when the step of hot pressing the resin film is taken place, the resin film has had an inner surface thereof provided with an ink layer having a printed graph.

6. The method of claim 3, wherein the metal roller has a surface provided with an embossed pattern, and the metal roller has the heating temperature set to be between the melting point of the resin film and the melting point of the hot-melt adhesive layer and to be able to soften the resin film, so that after the resin film is pressed by the metal roller with the embossed pattern, an embossed surface in accordance with the embossed pattern is formed on the resin film.

7. The method of claim 3, wherein the metal roller has a surface provided with an embossed pattern, and the metal roller has the heating temperature set to be between the melting point of the resin film and the melting point of the hot-melt adhesive layer and to be able to soften the resin film and the cushion simultaneously, so that after the resin film, the hot-melt adhesive layer, and the outer surface of the cushion are pressed by the metal roller with the embossed pattern, embossed surfaces in accordance with the embossed pattern are formed on the resin film, the hot-melt adhesive layer, and the cushion.

8. The method of claim 3, wherein after the step of hot pressing the resin film, there is a step of heating the cushion using a heater, and roll pressing the cushion using a forming roller whose surface has an embossed pattern, so that after the cushion is pressed by the forming roller with the embossed pattern, an embossed surface in accordance with the embossed pattern is formed on the cushion.

9. The method of claim 8, wherein before the step of applying the hot-melt adhesive, there is a step of printing a graph with ink on the outer surface of the cushion to form an ink layer.

10. The method of claim 8, wherein when the step of hot pressing the resin film is taken place, the resin film has had an inner surface thereof provided with an ink layer having a printed graph.
